(19) United States
(12) Patent Application Publication
(10) Pub. No.: US 2008/0008190 A1
(43) Pub. Date: Jan. 10, 2008

(54) Method and apparatus for distributing statistical multiplex signals to handheld devices

(75) Inventor: Erik Elstermann, Carlsbad, CA (US)

Correspondence Address: Motorola, Inc.;Law Department, 1303 East Algonquin Road, 3rd Floor, Schaumburg, IL, 60196, US

(73) Assignee: General Instrument Corporation

(21) Appl. No.: 11/482,407

(22) Filed: Jul. 7, 2006

(51) Int. Cl. H04L 12/56

(52) U.S. Cl. 370/395.41

(57) ABSTRACT

An aspect of the invention relates to a method and apparatus for statistically multiplexing content from a plurality of encoders. In one example, a respective need data value from each of the encoders is received. A separate bandwidth allocation is designated for each of the encoders based on the respective need data value, wherein the separate bandwidth allocations do not collectively exceed an aggregate bandwidth threshold level. Afterwards, a burst identifier and the separate bandwidth allocations are transmitted to each of the encoders.

### BACKGROUND OF THE INVENTION

1. Field of the Invention

Embodiments of the present invention generally relate to the delivery of digital content to handheld devices. More specifically, the present invention relates to a method and apparatus for generating statistically multiplexed signals to be distributed over a Digital Video Broadcasting-Handheld (DVB-H) network.

2. Description of the Related Art

Presently, programming providers desire the ability to deliver digital content to handheld mobile devices in an effective manner. Such content is typically delivered to the mobile devices via a distribution network, such as a DVB-H network. The content may include various national news, sports, and entertainment channels. However, due to the power requirements needed to receive and display downloaded digital video content, there is an immediate need to minimize power consumption experienced by a handheld device. One such solution is the implementation of a time-slicing technique. Generally speaking, time-slicing involves the transmission of data bursts associated with a plurality of channels on an alternating basis. The advantage of this method is that certain portions of the receiver circuitry are not powered on all of the time. Instead, the receiver only needs to be turned on when the appropriate data burst (corresponding to the tuned channel) is to be received. Information within the received packets informs the receiver when to expect the next packet burst. Consequently, the handset is able to retain and conserve energy in a more effective manner. However, this time-slicing technique is not compatible with other performance enhancing techniques, such as statistical multiplexing. Statistical multiplexing is a technique that considers the picture complexity of downloaded content from a given channel. Notably, bits are allocated to each channel of the multiplexed signal based on the complexity of the video or service (i.e., channels exhibiting excessive “motion” may be allocated a greater number of bits than a channel generally exhibiting a static background such as a newscast) as opposed to assigning a fixed bit allocation to every channel.

Thus, there is a need in the art for a more effective method and apparatus for statistical multiplexed signals in DVB-H receivers.

### SUMMARY OF THE INVENTION

In one embodiment, an aspect of the invention relates to a method and apparatus for statistically multiplexing content from a plurality of encoders. Specifically, a respective need data value from each of the encoders is received. A separate bandwidth allocation is designated for each of the encoders based on the respective need data value, wherein the separate bandwidth allocations do not collectively exceed an aggregate bandwidth threshold level. Afterwards, a burst identifier and separate bandwidth allocations are transmitted to each of the encoders.

### BRIEF DESCRIPTION OF THE DRAWINGS

So that the manner in which the above recited features of the present invention can be understood in detail, a more particular description, of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of digital content delivery network in accordance with the present invention;

FIG. 2 depicts a block diagram of an exemplary transport stream utilized in a statistical multiplexing scheme in accordance with the present invention;

FIG. 3 depicts a block diagram of an exemplary broadcast station utilized in accordance with the present invention;

FIG. 4 depicts a method for distributing statistically multiplexed data to a handheld device in accordance with the present invention;

FIG. 5 depicts a block diagram of an exemplary statistical multiplexing operation in accordance with the present invention; and

FIG. 6 is a block diagram depicting an exemplary embodiment of a computer suitable for implementing the processes and methods described herein.

To facilitate understanding, identical reference numerals have been used, wherever possible, to designate identical elements that are common to the figures.

### DETAILED DESCRIPTION

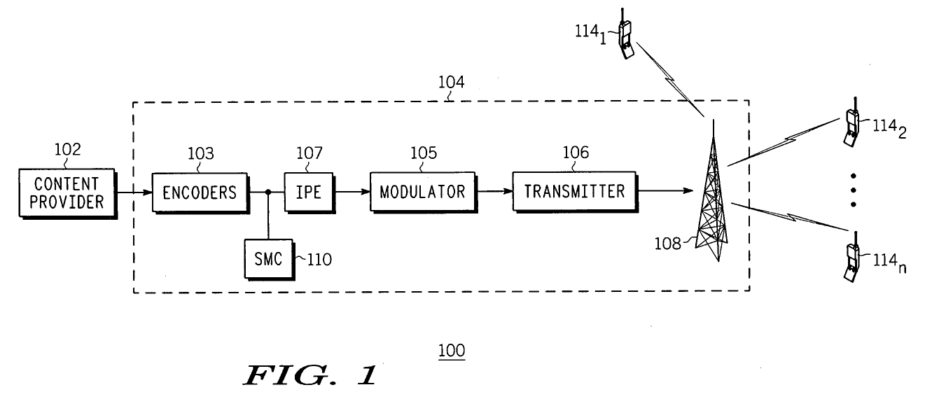

FIG. 1 depicts one embodiment of a digital content delivery network 100, which includes a content provider 102, an exemplary broadcast site 104, and a plurality of handheld mobile devices 114_{1 . . . n}. The broadcast site 104 may comprise a set of encoders 103, an Internet Protocol encapsulator (IPE) 107, a statistical multiplexing controller (SMC) 110, a modulator 105, a transmitter 106, and at least one transmission tower 108. The content provider 102 may be any entity that offers and provides digital programming content or services. In one embodiment, the content provider 102 supplies a plurality of channels, each of which contains a different digital video programming stream, to the broadcast site 104. Although only one content provider is depicted in FIG. 1, those skilled in the art realize that more than one content provider may supply a given broadcast site with digital content.

The broadcast site 104 may comprise a central location or station that receives digital content from at least one content provider. The broadcast site 104 is primarily responsible for facilitating the transmission of the received programming content. In one embodiment, the broadcast site 104 includes a set of encoders 103 that is configured to receive the programming content from the content provider (e.g., one encoder for each channel). Generally, each encoder converts the received programming content into an Internet Protocol (IP) packet stream. In one embodiment of the present invention, the IP packet streams are statistically multiplexed with the aid of the SMC 110. The processed IP packet streams are subsequently provided to the IPE 107. In one embodiment, the IPE 107 is the system component that receives all of the IP packet streams from the encoders 103 and converts the IP data into MPEG-2 bursts. At this point, the data bursts are provided to the modulator 105. The modulator 105 (e.g., a DVB-H modulator) is configured to blend the content signal into a carrier signal for distribution. The modulated signal is then forwarded to a transmitter 106 (e.g., a DVB-H transmitter) which in turn provides the signal to a transmission tower 108. Once the signal is broadcasted from the transmission tower 108, the modulated signal is received by one or more mobile devices 114_{1 . . . n} (e.g., handheld mobile receivers) as depicted in FIG. 1.

In one embodiment, the broadcast site 104 may be configured to statistically multiplex digital content associated with a plurality of channels. Notably, by delivering a DVB-H multiplex signal in which all the channels are statistically multiplexed, the quality of the delivered video may be improved, a greater number of services may be provided, and/or additional error correction overhead may be introduced. These enhancements may be achieved by implementing a statistical multiplexing control application that is capable of coordinating the encoders, which are used to compress, transcode, and deliver content. Furthermore, channel acquisition performance will also be improved by aligning I-frame data with DVB-H time-slice bursts.

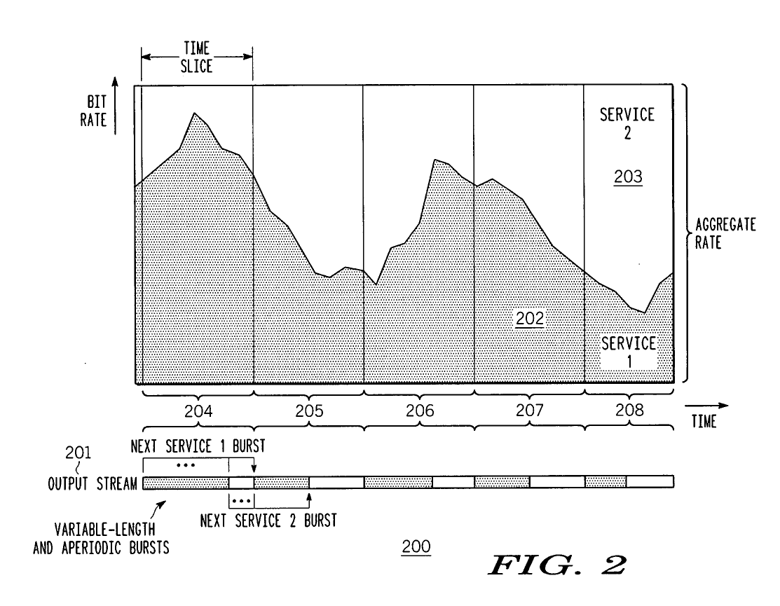

FIG. 2 illustrates a graphical depiction 200 of two-channel statistical multiplexing. Although only two channels are shown, those skilled in the art realize more channels may be multiplexed in this fashion. The graph 202 depicts the bit rate requirements for both a Service 1 and a Service 2. In one embodiment, Service 1 and Service 2 may be television programs, music videos, movies, and the like. Looking at time-slice 204, Service 1 is shown to have a greater bit rate requirement than Service 2 (as opposed to, for example, time-slice 208). Service 1 may require a higher bit rate due to the complexity of its programming content. For example, Service 1 may be a sporting event that involves a significant amount of object movement and background changes. Conversely, Service 2 may not require as much bandwidth because the associated channel may only be showing a newscast where the background is relatively stationary and object movement is minimal.

The output stream 201 from an IPE depicts the variable length and aperiodic data bursts contained in time slices (e.g., time-slices 204-208). For example, the first time-slice shows that the packets for Service 1 are transmitted first, followed by all of the packets for Service 2. In a conventional multiplexing scheme, the average number of packets are generally identical (i.e., the number of packets is not variable) and remain constant for each subsequent time-slice. Conversely, in a statistically multiplexing scheme, the number of packets for Service 1 may differ in subsequent time-slices to reflect the changing complexity of the programming content over time. FIG. 2 also depicts how the arrival time of the next service burst is conveyed to a receiver. Namely, a data burst for a given service contains information (e.g., in a message header) detailing when the next relevant burst will arrive for a given service. This feature enables the receiver to power down during times of non-use.

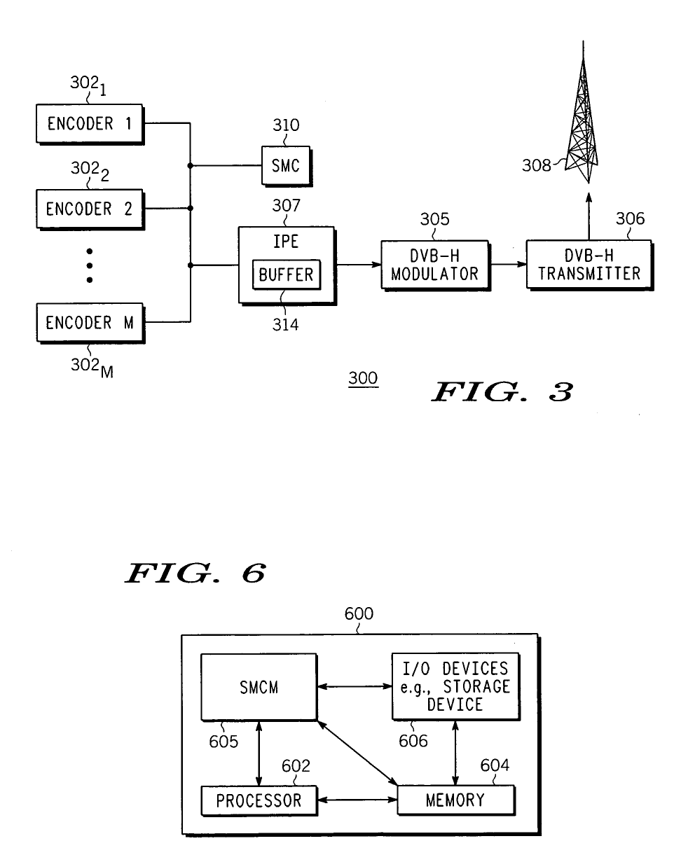

FIG. 3 illustrates one example of a broadcast site capable of implementing a statistical multiplexing control application. The program provider broadcast site 300 comprises a plurality of encoders 302_{1 . . . m} (e.g., AVC encoders), an IP encapsulator (IPE) 307, a statistical multiplexing controller (SMC) 310, a modulator 305, and a broadcast site transmitter 306.

The AVC encoders 302_{1 . . . m} initially receive programming content from a program provider for encoding (e.g., each encoder receives the content from a separate channel). In one embodiment, the programming content may be encoded using H.264 or any other like protocol. The encoders 302_{1 . . . m} are also responsible for transmitting a “need” data value to the SMC 310. In one embodiment, the need data value is a numerical value that represents the picture complexity of the digital video being encoded.

Each encoder also inserts a burst identifier (which is assigned by the SMC 310) into packets (e.g., an IP header) in order to identify the relevant packets that will constitute a portion of a time-slice burst transmitted by the IPE (i.e., each time-slice burst, along with its associated packets from different encoders, is identified by its own burst identifier). The encoded IP packet streams from the encoders 302_{1 . . . m} are ultimately forwarded to the IP encapsulator 307 for encapsulation.

The SMC 310 is responsible for facilitating the statistical multiplexing of digital content. Initially, the SMC 310 receives need data values from the encoders. The SMC 310 subsequently responds by processing the need data values and dynamically assigning a bit rate allocation (e.g., bandwidth) and burst identifier to each encoder. The burst identifier serves as a label to group all the different packets that constitutes a single time-slice. Similarly, the SMC 310 synchronizes the encoder bandwidth allocations during each burst cycle so that a maximum aggregate rate (Rₘₐₓ) is not collectively exceeded by the encoders (for a given time slice). The SMC 310 also receives feedback from the IPE 307 regarding the overestimation or the underestimation of overhead introduced by the IPE. Accordingly, the SMC 310 adjusts its previous Rₘₐₓ rate in light of the feedback. The SMC 310 may be embodied as software or as hardware. As software, the SMC 310 may reside in the IPE 307 or in the encoders. Alternatively, the SMC 310 may exist as a stand-alone computer or another similar hardware device.

The IP encapsulator (IPE) 307 is a component used to collect video streams from the encoders to form an encapsulated DVB-H transport stream. The IPE 307 contains a buffer 314 that is used to temporarily store encoder data. The IPE 307 uses the burst identifier attached to each packet to determine which packets should compose a particular time-slice burst. The IPE 307 provides buffer usage feedback to the SMC 310. For example, the IPE 307 informs the SMC 310 if there is an underestimation or overestimation of overhead introduced by the IPE when encapsulating the encoder IP packets into MPEG-2 transport packets. After encapsulating the IP packets into an MPEG transport stream, the IPE 307 transmits the transport stream as output to the modulator 305 at a fixed bit rate. The modulator 305 (e.g., a DVB-H modulator) processes the signal stream and forwards it to a transmission tower 308 via the broadcast site transmitter 306 (e.g. a DVB-H transmitter).

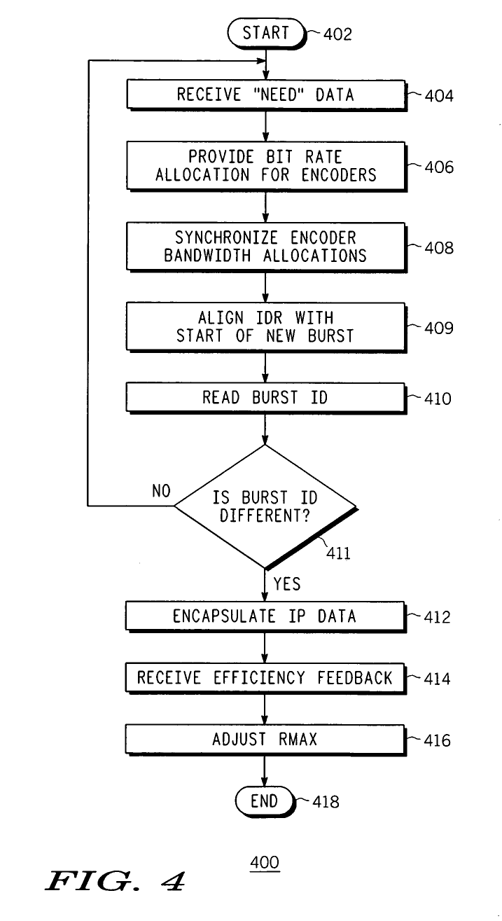

FIG. 4 illustrates a method 400 for distributing statistical multiplexed signals to a handheld device in accordance with the present invention. Method 400 begins at step 402 and proceeds to step 404, where “need” data is received. In one embodiment, the SMC 310 receives a need data value (e.g., a numerical value that represents the picture complexity of video) from each encoder.

At step 406, a bit rate allocation is provided to encoders. In one embodiment, the SMC 310 uses the need data value(s) to determine the bit rate allocation of each encoder. More specifically, the SMC 310 processes the need data value from each encoder and allocates a corresponding number of bits based on the need data value. This allocation is conducted with respect to a maximum aggregate value (e.g., Rₘₐₓ), which represents the total bandwidth available for a given time-slice burst. At this time, a burst identifier is assigned to each encoder.

At step 408, the encoder bandwidth allocations are synchronized. In one embodiment, the SMC 310 synchronizes the bandwidth allocations for each encoder during each burst cycle by using a maximum aggregate rate. Notably, the maximum aggregate rate (Rₘₐₓ) is not to be exceeded (i.e., Rₘₐₓ is tied to the maximum output rate of the IP encapsulator) and the bandwidth allocations are synchronized accordingly so that the aggregate bit rate allocations to the encoders are less than Rₘₐₓ. In one embodiment, Rₘₐₓ is calculated in light of Multiprotocol Encapsulation (MPE), MPE Forward Error Correction (MPE-FEC), and Moving Pictures Experts Group (MPEG) transport packetization considerations.

At step 409, the burst identifier is encoded into the encoder output. Notably, each burst identifier is unique to a given time-slice burst. That is, the burst identifier is provided to all the encoders, which in turn respectively insert the burst identifier into the packets that will compose the given time-slice burst. In one embodiment, the burst identifier is placed within an IP header.

At step 410, the IPE 307 receives an IP packet stream from an encoder and reads the associated burst identifier to determine if the end of the burst has been received. If the IP packet is not at the end of the stream, the IPE 307 continues to buffer the incoming IP packets. If the burst identifier of the received IP packet is different from the burst identifier of the previously received IP packet and thus indicates a new burst, then the method 400 continues to step 412.

At step 412, the accumulated IP data in the IPE buffer 314 is encapsulated. Notably, the data is ready for transmission and the IPE encapsulates the IP datagrams into MPEG (e.g., MPEG-2) transport packets and transmits the encapsulated data. In one embodiment, the IPE also computes forward error correction (FEC) data. Similarly, the IPE 307 may encrypt the MPEG packets that are to be transmitted.

At step 414, efficiency feedback is received. In one embodiment, the SMC 310 receives bit rate allocation overhead feedback from the IPE 307. Notably, the feedback from the IPE 307 pertains to whether the IPE output is tending to overflow or underflow.

At step 416, Rₘₐₓ is adjusted. In one embodiment, the SMC adjusts the Rₘₐₓ in response to the efficiency feedback received by the IPE. For example, the SMC adjusts the existing Rₘₐₓ (e.g., raising or lowering the value of Rₘₐₓ) depending on the feedback received (overrun and underrun). The method 400 continues to step 418 and ends.

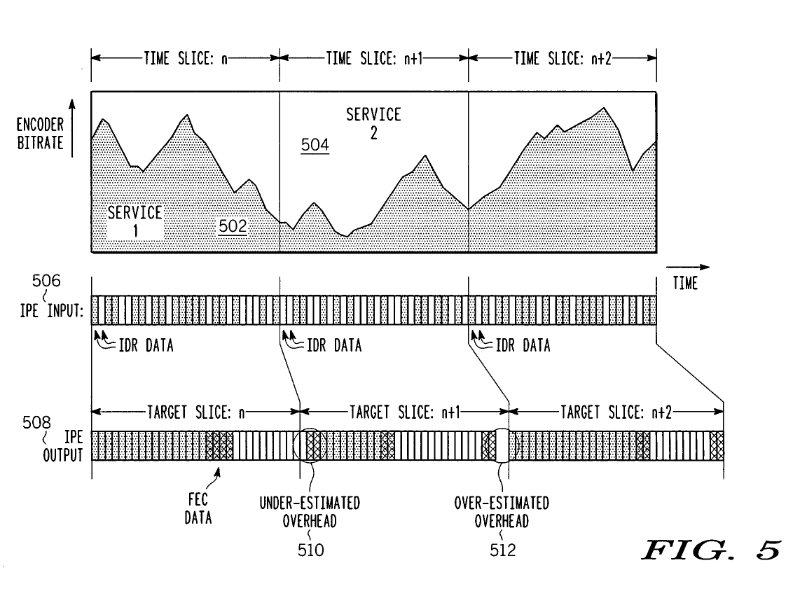

FIG. 5 illustrates an exemplary scenario that is consistent with the method 400 detailed in FIG. 4. Namely, FIG. 5 depicts a scenario wherein the digital content (e.g., Service A and Service B) from two channels are statistically multiplexed. Initially, the SMC 310 is configured with a target time-slice period (T_{burst}), a burst rate (R_{burst}), an initial overhead estimate (OH) for MPE, MPE-FEC, and MPEG-2 transport packetization. Suppose the parameters are assigned the following values: T_{burst}=2 seconds, R_{burst}=1 Mbps, and OH=10%. Using these values the SMC 310 determines the maximum capacity available, Rₘₐₓ, for the first time-slice, “n”. The SMC 310 utilizes the formula, T_{slice}*R_{burst}/(1+OH), to determine Rₘₐₓ=1.82 Mbits.

After receiving the need data from the encoders associated with Service A and Service B, the SMC 310 dynamically allocates bits to the respective encoders based on the most recent need data. Specifically, the total amount of bits allocated to service A and B cannot exceed 1.82 Mbits. The SMC 310 also assigns a burst identifier (e.g., slice “n1”) that corresponds to the bit allocation. Consequently, each encoder tags each packet belonging to slice “n” with the burst identifier. Each encoder also encodes the first picture data as an I-frame or Instantaneous Decoder Refresh (IDR) picture data.

The encoders transmit their respective burst portions (e.g., via a stream 506) to the IPE 307, which stores the received data in a buffer 314. Notably, the IPE 307 is able to use the burst identifiers to distinguish among previous, current and next time-slice data. The IPE 307 then encapsulates the data and arranges the data that belongs to a given time-slice according to the providing encoder (e.g., IPE output 508 is arranged as Service A then Service B). The IPE 307 subsequently FECs the data and ultimately bursts the data.

The IPE 307 then compares the actual slice duration to the target slice duration utilized by the SMC 310. If the actual slice duration is greater than the target slice duration, the SMC 310 under-estimated the encapsulation overhead (OH). This is illustrated at 510 in FIG. 5. If the actual slice duration is less than T_{slice}, then the SMC 310 over-estimated OH (e.g., see 512). Once the appropriate determination is made, the IPE 307 provides new overhead information (e.g., OH=12%) to the SMC 310. The SMC 310 then revises the capacity estimate for the next time-slice (e.g., time-slice “n+1”) using the actual OH for time-slice “n”. Namely, Rₘₐₓ=T_{slice}*R_{burst}/(1.12)=1.79 Mbits. The process then repeats itself with the SMC 310 dynamically allocating bits to both encoders after receiving the respective need data for time-slice “n+1”.

FIG. 6 depicts a high level block diagram of a general purpose computer suitable for use in performing the functions described herein. As depicted in FIG. 6, the system 600 comprises a processor element 602 (e.g., a CPU), a memory 604, e.g., random access memory (RAM) and/or read only memory (ROM), a statistical multiplexing control module 605, and various input/output devices 606 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASICs), a general purpose computer or any other hardware equivalents. In one embodiment, the present statistical multiplexing control module or process 605 can be loaded into memory 604 and executed by processor 602 to implement the functions as discussed above. As such, the present statistical multiplexing control process 605 (including associated data structures) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for statistically multiplexing content from encoders, comprising:
receiving a respective need data value from each of said encoders;
designating a separate bandwidth allocation for each of said encoders based on said respective need data value, wherein said separate bandwidth allocation of each of said encoders collectively do not exceed an aggregate bandwidth threshold level; and
transmitting a burst identifier and said separate bandwidth allocation for each of said encoders to each of said encoders.

2. The method of claim 1, wherein each of said encoders generates a packet stream in accordance with said separate bandwidth allocation thereof.

3. The method of claim 2, wherein a first packet of said packet stream comprises at least one of: an Instantaneous Decoder Refresh (IDR) picture or an I-frame.

4. The method of claim 3, wherein packets within said packet stream from each of said encoders contains said burst identifier.

5. The method of claim 4, wherein said packet stream from each of said encoders is converted into a separate service data burst by an Internet Protocol Encapsulator (IPE).

6. The method of claim 5, wherein said separate service data burst from a first encoder of said encoders contains data pertaining to an arrival time of a next separate service data burst from said first encoder of said encoders.

7. The method of claim 6, wherein said IPE buffers said packet stream from each of said plurality of encoders to form time-slice data bursts containing said burst identifier.

8. The method of claim 7, further comprising:
receiving feedback data from said IPE; and
adjusting said aggregate bandwidth threshold level based on said feedback data.

9. A computer readable medium having stored thereon instructions that, when executed by a processor, causes the processor to perform a method for statistically multiplexing content from encoders, comprising:
receiving a respective need data value from each of said encoders;
designating a separate bandwidth allocation for each of said encoders based on said respective need data value, wherein said separate bandwidth allocation of each of said encoders collectively do not exceed an aggregate bandwidth threshold level; and
transmitting a burst identifier and said separate bandwidth allocation for each of said encoders to each of said encoders.

10. The computer readable medium of claim 9, wherein each of said encoders generates a packet stream in accordance with said separate bandwidth allocation thereof.

11. The computer readable medium of claim 10, wherein a first packet of said packet stream comprises at least one of: an Instantaneous Decoder Refresh (IDR) picture or an I-frame.

12. The computer readable medium of claim 11, wherein packets within said packet stream from each of said encoders contains said burst identifier.

13. The computer readable medium of claim 12, wherein said packet stream from each of said encoders is converted into a separate service data burst by an Internet Protocol Encapsulator (IPE).

14. The computer readable medium of claim 13, wherein said separate service data burst from a first encoder of said encoders contains data pertaining to an arrival time of a next separate service data burst from said first encoder of said encoders.

15. The computer readable medium of claim 14, wherein said IPE buffers said packet stream from each of said plurality of encoders to form time-slice data bursts containing said burst identifier.

16. The computer readable medium of claim 15, further comprising:
receiving feedback data from said IPE; and
adjusting said aggregate bandwidth threshold level based on said feedback data.

17. An apparatus for statistically multiplexing content from a plurality of encoders, comprising:
means for receiving a respective need data value from each of said encoders;
means for designating a separate bandwidth allocation for each of said encoders based on said respective need data value, wherein said separate bandwidth allocation of each of said encoders collectively do not exceed an aggregate bandwidth threshold level; and
means for transmitting a burst identifier and said separate bandwidth allocation for each of said encoders to each of said encoders.

18. The apparatus of claim 17, wherein each of said encoders generates a packet stream in accordance with said separate bandwidth allocation.

19. The apparatus of claim 18, wherein a first packet of said packet stream comprises at least one of: an Instantaneous Decoder Refresh (IDR) picture or an I-frame.

20. The apparatus of claim 19, wherein packets within said packet stream from each of said encoders contains said burst identifier.

21. The apparatus of claim 20, wherein said packet stream from each of said encoders is converted into a separate service data burst by an Internet Protocol Encapsulator (IPE).

22. The apparatus of claim 21, wherein said separate service data burst from a first encoder of said encoders contains data pertaining to an arrival time of a next separate service data burst from said first encoder of said encoders.

23. The apparatus of claim 22, wherein said IPE buffers said packet stream from each of said plurality of encoders to form time-slice data bursts containing said burst identifier.

24. The apparatus of claim 23, further comprising:
means for receiving feedback data from said IPE; and
means for adjusting said aggregate bandwidth threshold level based on said feedback data.
